(19) United States
(12) Patent Application Publication
(10) Pub. No.: US 2010/0110411 A1
(43) Pub. Date: May 6, 2010

(54) ANTI-PIRACY CODING TECHNIQUE

(75) Inventors: Robert A. Olson, Moorpart, CA (US); Warren Raymond Proulx, JR., Burbank, CA (US); Jeffrey Marshall Wolf, Fullerton, CA (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/452,155

(22) PCT Filed: Jun. 25, 2007
(86) PCT No.: PCT/US2007/014891

§ 371 Date: Dec. 17, 2009

(51) Int. Cl. G03B 27/32

(52) U.S. Cl. 355/77

(57) ABSTRACT

An internegative duplicate (12), as used to make motion picture release prints, undergoes marking by exposing at least one area within at least one frame to provide a decodable pattern specific to the internegative duplicate. In this way, pirated copies of content made by a rogue laboratory can be tracked.

### TECHNICAL FIELD

This invention relates to a technique for forensically marking motion picture film for identifying the source of pirated copies.

### BACKGROUND ART

The conventional process for making a motion picture film begins the creation of an Original Camera Negative (OCN) obtained when a camera operator exposes a positive image onto a length of film. The OCN is printed onto a length of film stock, generally referred to as an interpositive because the interpositive, when developed, yields a positive image. The interpositive print then undergoes processing, including, but not limited to color-timing, to create an internegative duplicate which serves as the master for making exhibition release prints.

Traditionally, content creators, e.g., movie studios, have relied on outside service providers, such as Technicolor, Inc, among others to produce release prints from internegative duplicates. The number of internegative duplicates remains small and the number of the facilities at which printing of release prints occur remains limited so that the security surrounding internegative duplicates has remained manageable. However, the same cannot be said for release prints. For most feature presentations, a movie studio will order thousands of release prints, usually one for every theater exhibiting the presentation. Thus, the risk that a release print will undergo copying by an unscrupulous exhibitor remains very real. For that reason, many movie studios now insist that the service providers mark each release print with a detectable pattern unique to that print. In this way, a pirated copy of the print will contain the detectable pattern unique to that release print, thus allowing the movie studio to trace the pirated copy to the particular exhibitor who received that print. U.S. Patent Publication 2006/0286489 constitutes but one example of the various techniques that currently exist for marking release prints for tracking purposes.

As movie studios seek wider geographic distribution of their content, the ability to supply release prints from a limited number of domestic facilities on a timely basis has proven difficult. Consequently, service providers responsible for release print manufacture have sought to sub-contract this task to local in-country laboratories. Typically, the ability to monitor such in-country facilities to prevent against unauthorized production and distribution of release prints exists on a very limited basis if at all. Thus a rogue laboratory will typically use an Internegative to scan directly into a digital file for release on the Internet or a DVD. This usually happens when a film laboratory “loses” possession of the Internegative at some point in time, usually resulting from active cooperation with laboratory personnel.

Thus, a need exists for tracking release prints made by an unscrupulous laboratory.

### BRIEF SUMMARY OF THE PRESENT PRINCIPLES

Briefly, in accordance with a preferred embodiment of the present principles, there is provided a method for forensically marking an internegative duplicate which serves as a master to replicate release print. The method comprises the step of exposing the internegative duplicate to a beam of light to create at least one exposure pattern situated at least at one distinct location within the internegative duplicate that is separate from locations for accommodating decodable patterns in a release print made from the internegative duplicate.

### BRIEF SUMMARY OF THE DRAWINGS

FIG. 1 depicts a block schematic diagram of a system for exposing the internegative duplicate to a beam of light to create one or exposure pattern in accordance with the present principles; and

FIG. 2 depicts a frame of an internegative duplicate marked in accordance with the present

### DETAILED DESCRIPTION

As described in greater detail hereinafter, there is provided a technique for identifying the pirated copies of a motion picture film made by a rogue laboratory, that is, a laboratory that does not mark each individual release print as required by the content provider. In contrast to previous coding that required the placement of defects into the film, a practice unacceptable to many content providers, the technique of the present principles relies on non-destructive methods to mark an internegative duplicate.

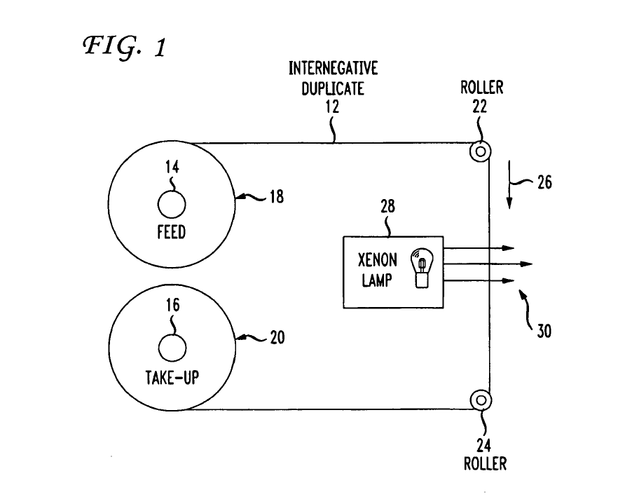

FIG. 1 depicts a block schematic diagram of a system 10 in accordance an illustrative embodiment of the present principles for marking an internegative duplicate 12. The system 10 includes motor-driven hubs 14 and 16, each mounting a separate one of a feed and take-up reels 18 and 20, respectively. At outset of the marking operation, the feed reel 18 contains a length of the internegative duplicate 12 as yet unmarked, whereas the take-up reel remains empty. Spaced rollers 22 and 24 serve to guide and engage the internegative duplicate supplied from the feed reel 18 and taken up by the take-up reel 20, respectively. The rollers 22 and 24 maintain the internegative 12 generally taut as it travels along a linear path 26. The rollers 22 and 24 need not be motor driven, but if so, then the rollers operate in synchronism with the motor-driven hubs 14 and 16. The motor-driven hubs 14 and 16 (and the rollers 22 and 24, when motor-driven) operate under servo control in accordance with the position of the internegative duplicate, as sensed by a position sensor (not shown) to allow precise positioning.

Located between the rollers 22 and 24 is a light 28 source, which generates a collinear light beam 30. In practice, the light source 28 typically comprises a Xenon lamp. Alternatively, the light source 28 could comprise a laser or the like. The orientation of the light source 28 relative to portion of the internegative duplicate 12 lying between the rollers 22 and 24 is such that the light beam 30 strikes the internegative duplicate generally perpendicular to its path of travel indicated by the arrow 28.

To commence the marking process, an operator will unroll a portion of the internegative duplicate 12 from the feed reel 16 and thread the internegative duplicate over the rollers 22 and 24 for engagement before securing the free end onto the take-up reel 18. Thereafter, the operator will advance the internegative duplicate 12 to align a particular frame of interest opposite the light source 28 to enable exposure of that frame by the light beam 30. In practice, the light beam 30 exposes a given frame of the internegative duplicate 12 to create a particular pattern specific to internegative. Typically, several frames undergo exposure to create the same pattern. The exposure pattern corresponds to a code that identifies the specific recipient of that internegative duplicate to facilitate identification of a rogue laboratory that would distribute pirated copies of release prints made from that internegative. The process of exposing one or more frames within the internegative will hereinafter be referred to as “marking”.

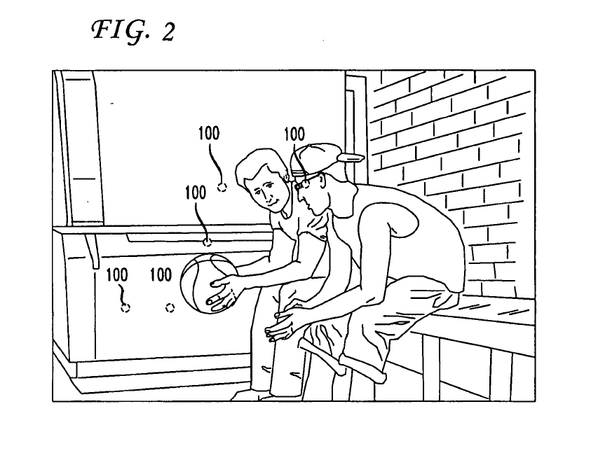

FIG. 2 depicts an exemplary frame of the internegative duplicate 12 illustrating exposure areas 100 which collectively comprise the exposure pattern within that frame. Although FIG. 2 depicts multiple exposure areas 100, a single exposure area within a single frame could suffice to mark an internegative. Alternatively, multiple exposure patterns could exist in a single frame, or multiple frames could exist, each having at least one exposure pattern.

The identity of the frame and the location(s) frame of the exposed areas 100 within that comprising the exposure pattern, as well as the particular shape of the pattern remain unknown to the laboratory receiving the internegative duplicate for the purpose of making release prints. In addition, the locations of the exposed areas on the internegative duplicate are distinct relative to locations in release prints made from the internegative duplicate intended to accommodate decodable exposure patterns to mark such release prints.

Generally, a laboratory under subcontract to make release prints from an internegative duplicate, such as internegative duplicate 12, will have an obligation to mark each release print with a specific decodable pattern to enable tracking of pirated copies of the underlying content. A rogue laboratory typically will not mark all release prints to afford itself the opportunity to distribute pirated copies of the underlying content. However, by marking the internegative duplicate, the content owner or its agent, can track release prints made from the internegative duplicate and identify the rogue laboratory responsible for such piracy irrespective of whether the release print(s) contains any markings. Choosing the locations of the exposure patterns 100 in the internegative duplicate to be distinct from the intended locations for marking in release prints made from the internegative duplicate facilitates decoding of the internegative exposure patterns.

The foregoing describes a technique for marking an internegative duplicate to identify the source of pirated copies.

1. A method comprising the step of:
exposing an internegative duplicate to a beam of light to create at least one exposure area in at least one distinct location within the internegative duplicate for identification separate from locations in a release print made from the internegative duplicate intended to accommodate a decodable pattern.

2. The method according to claim 1 further comprising the step of exposing the internegative duplicate to create a plurality exposure areas to establish a decodable pattern in a distinct location.

3. The method according to claim 1 further comprising the step of exposing the internegative duplicate to create at least one exposure area in each of a plurality distinct locations.

4. The method according to claim 1 further comprising the step of exposing the internegative duplicate to create multiple exposure areas in each of a plurality distinct locations.

5. The method according to claim 1 further comprising the step of making a release print from the internegative duplicate following the exposing step.

6. A method comprising the step of:
exposing an internegative duplicate to a beam of light to create at least one exposure area for identification in at least one distinct location within the internegative duplicate unknown to a recipient of the internegative duplicate.

7. The method according to claim 6 further comprising the step of exposing the internegative duplicate to create a plurality exposure areas to establish a decodable pattern in a distinct location.

8. The method according to claim 6 further comprising the step of exposing the internegative duplicate to create at least one exposure area in each of a plurality distinct locations.

9. The method according to claim 6 further comprising the step of exposing the internegative duplicate to create multiple exposure areas in each of a plurality distinct locations.

10. The method according to claim 6 further comprising the step of making a release print from the internegative duplicate following the exposing step.
